(19) United States
(12) Patent Application Publication
(10) Pub. No.: US 2021/0294303 A1
(43) Pub. Date: Sep. 23, 2021

(54) IN-PROCESS TRIGGER MANAGEMENT FOR ROBOTIC PROCESS AUTOMATION (RPA)

(71) Applicant: UiPath, Inc., New York, NY (US)

(72) Inventors: Brandon Nott, Bellevue, WA (US); Justin Marks, Redmond, WA (US)

(73) Assignee: UiPath, Inc., New York, NY (US)

(21) Appl. No.: 16/821,489

(22) Filed: Mar. 17, 2020

(51) Int. Cl. G05B 19/4155; B25J 9/16

(52) U.S. Cl. CPC G05B 19/4155; G05B 2219/50391; B25J 9/1661

(57) ABSTRACT

A computing device may monitor, in relation to the robotic automation process, for an event or an activity associated with a trigger. The trigger may be defined by code, a definition file, or a configuration file. A match may be identified for the event or the activity associated with the trigger. The computing device may instruct, on a condition that the trigger is identified, a robot executor to initiate a process during the robotic automation process.

### BACKGROUND

Robotic process automation (RPA) may automate operations, functions, components, tasks, or workflows on enterprise platforms, virtual machines (VMs), remote desktops, applications on the cloud, desktop applications, mobile applications, or the like. In RPA deployments with a robot(s), such as an attended robot(s), triggers may allow software or applications to respond to a user event, system event, a change to a file, external event on another system, or the like. A trigger may be utilized, loaded, ran, exercised, or executed in relation to or within the context of an RPA process or RPA package to initiate a process, event, or activity for an application.

When a large number of triggers are active on a local machine, client device, operating system tray, computing device, or the like, substantial resources may be consumed. In configurations with one or more triggers in a process, including for a single process, simultaneous processes, concurrent processes, or the like, it is desirable at scale to manage or reduce overhead for RPA deployments.

### SUMMARY

A trigger(s) may be configured to run or execute automatically within, during, or in a process, package, workflow, or the like in relation to robotic automation of an application. A robot may monitor or listen for a trigger event or activity in a process. When a match is identified for a trigger, the process related to the identified trigger may be initiated or ran. In addition, a robotic process automation (RPA) robot can register, run, queue, locally edit, prioritize, or the like, based on a trigger or related action or activity.

### BRIEF DESCRIPTION OF THE DRAWING(S)

A more detailed understanding may be had from the following description, given by way of example in conjunction with the accompanying drawings, wherein like reference numerals in the figures indicate like elements, and wherein:

FIG. 1A is an illustration of robotic process automation (RPA) development, design, operation, or execution;

FIG. 1B is another illustration of RPA development, design, operation, or execution;

FIG. 10 is an illustration of a computing system or environment;

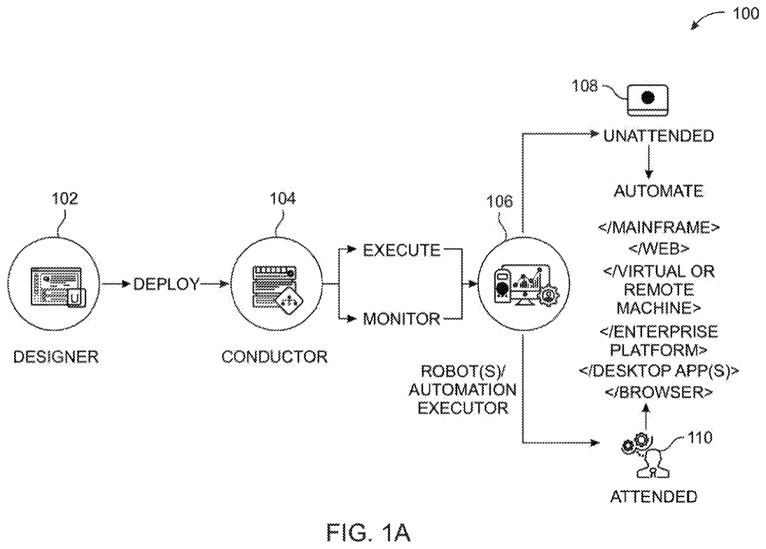

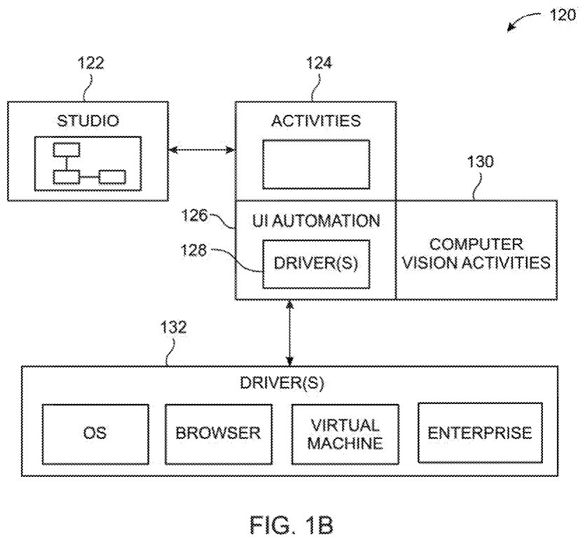

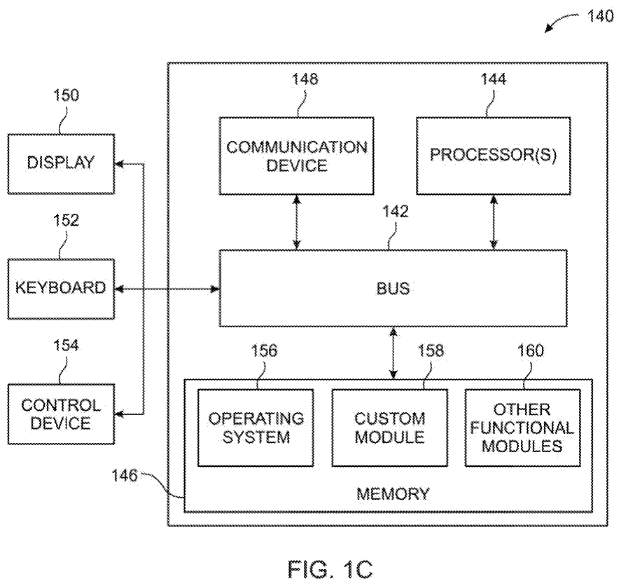

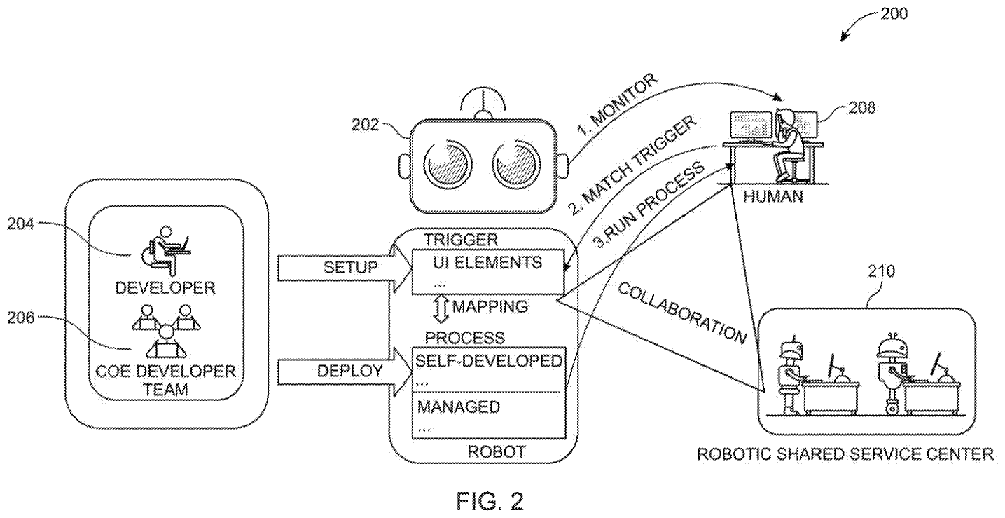

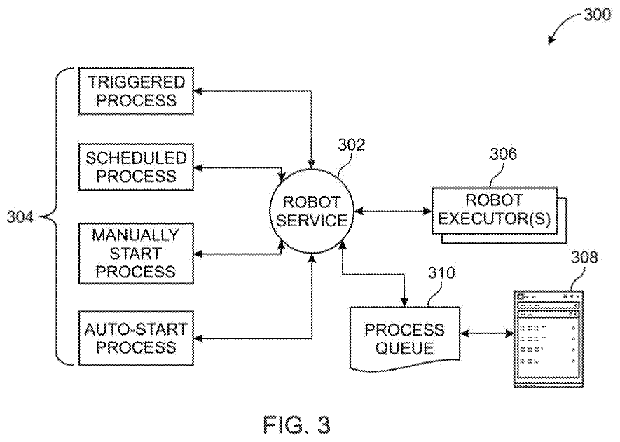

FIG. 1A is an illustration of robotic process automation (RPA) development, design, operation, or execution;

FIG. 2 is an illustration of an example of in-process trigger monitoring, listening, or management;

FIG. 3 is an illustration of an example of process queue management for a robot(s);

FIG. 4 is another illustration of an example of in-process trigger monitoring or listening; and

FIG. 5 is an illustration of an example of a process for in-process triggering.

### DETAILED DESCRIPTION

For the methods and processes described herein, the steps recited may be performed out of sequence in any order and sub-steps not explicitly described or shown may be performed. In addition, “coupled” or “operatively coupled” may mean that objects are linked but may have zero or more intermediate objects between the linked objects. Also, any combination of the disclosed features/elements may be used in one or more embodiments. When using referring to “A or B”, it may include A, B, or A and B, which may be extended similarly to longer lists. When using the notation X/Y it may include X or Y. Alternatively, when using the notation X/Y it may include X and Y. X/Y notation may be extended similarly to longer lists with the same explained logic.

FIG. 1A is an illustration of robotic process automation (RPA) development, design, operation, or execution 100. Designer 102, sometimes referenced as a studio, development platform, development environment, or the like may be configured to generate code, instructions, commands, or the like for a robot to perform or automate one or more workflows. From a selection(s), which the computing system may provide to the robot, the robot may determine representative data of the area(s) of the visual display selected by a user or operator. As part of RPA, shapes such as squares, rectangles, circles, polygons, freeform, or the like in multiple dimensions may be utilized for UI robot development and runtime in relation to a computer vision (CV) operation or machine learning (ML) model.

Non-limiting examples of operations that may be accomplished by a workflow may be one or more of performing login, filling a form, information technology (IT) management, or the like. To run a workflow for UI automation, a robot may need to uniquely identify specific screen elements, such as buttons, checkboxes, text fields, labels, etc., regardless of application access or application development. Examples of application access may be local, virtual, remote, cloud, Citrix®, VMWare®, VNC®, Windows® remote desktop, virtual desktop infrastructure (VDI), or the like. Examples of application development may be win32, Java, Flash, hypertext markup language (HTML), HTMLS, extensible markup language (XML), JavaScript, C#, C++, Silverlight, or the like.

A workflow may include, but are not limited to, task sequences, flowcharts, Finite State Machines (FSMs), global exception handlers, or the like. Task sequences may be linear processes for handling linear tasks between one or more applications or windows. Flowcharts may be configured to handle complex business logic, enabling integration of decisions and connection of activities in a more diverse manner through multiple branching logic operators. FSMs may be configured for large workflows. FSMs may use a finite number of states in their execution, which may be triggered by a condition, transition, activity, or the like. Global exception handlers may be configured to determine workflow behavior when encountering an execution error, for debugging processes, or the like.

A robot may be an application, applet, script, or the like, that may automate a UI transparent to an underlying operating system (OS) or hardware. At deployment, one or more robots may be managed, controlled, or the like by a conductor 104, sometimes referred to as an orchestrator. Conductor 104 may instruct or command robot(s) or automation executor 106 to execute or monitor a workflow in a mainframe, web, virtual machine, remote machine, virtual desktop, enterprise platform, desktop app(s), browser, or the like client, application, or program. Conductor 104 may act as a central or semi-central point to instruct or command a plurality of robots to automate a computing platform.

In certain configurations, conductor 104 may be configured for provisioning, deployment, configuration, queueing, monitoring, logging, and/or providing interconnectivity. Provisioning may include creating and maintenance of connections or communication between robot(s) or automation executor 106 and conductor 104. Deployment may include assuring the delivery of package versions to assigned robots for execution. Configuration may include maintenance and delivery of robot environments and process configurations. Queueing may include providing management of queues and queue items. Monitoring may include keeping track of robot identification data and maintaining user permissions. Logging may include storing and indexing logs to a database (e.g., an SQL database) and/or another storage mechanism (e.g., ElasticSearch®, which provides the ability to store and quickly query large datasets). Conductor 104 may provide interconnectivity by acting as the centralized point of communication for third-party solutions and/or applications.

Robot(s) or automation executor 106 may be configured as unattended 108 or attended 110. For unattended 108 operations, automation may be performed without third party inputs or control. For attended 110 operation, automation may be performed by receiving input, commands, instructions, guidance, or the like from a third party component. Unattended 108 or attended 110 robots may run or execute on mobile computing or mobile device environments.

A robot(s) or automation executor 106 may be execution agents that run workflows built in designer 102. A commercial example of a robot(s) for UI or software automation is UiPath Robots™. In some embodiments, robot(s) or automation executor 106 may install the Microsoft Windows® Service Control Manager (SCM)-managed service by default. As a result, such robots can open interactive Windows® sessions under the local system account, and have the rights of a Windows® service.

In some embodiments, robot(s) or automation executor 106 may be installed in a user mode. These robots may have the same rights as the user under which a given robot is installed. This feature may also be available for High Density (HD) robots, which ensure full utilization of each machine at maximum performance such as in an HD environment.

In certain configurations, robot(s) or automation executor 106 may be split, distributed, or the like into several components, each being dedicated to a particular automation task or activity. Robot components may include SCM-managed robot services, user mode robot services, executors, agents, command line, or the like. SCM-managed robot services may manage or monitor Windows® sessions and act as a proxy between conductor 104 and the execution hosts (i.e., the computing systems on which robot(s) or automation executor 106 is executed). These services may be trusted with and manage the credentials for robot(s) or automation executor 106.

User mode robot services may manage and monitor Windows® sessions and act as a proxy between conductor 104 and the execution hosts. User mode robot services may be trusted with and manage the credentials for robots. A Windows® application may automatically be launched if the SCM-managed robot service is not installed.

Executors may run given jobs under a Windows® session (i.e., they may execute workflows). Executors may be aware of per-monitor dots per inch (DPI) settings. Agents may be Windows® Presentation Foundation (WPF) applications that display available jobs in the system tray window. Agents may be a client of the service. Agents may request to start or stop jobs and change settings. The command line may be a client of the service. The command line is a console application that can request to start jobs and waits for their output.

In configurations where components of robot(s) or automation executor 106 are split as explained above helps developers, support users, and computing systems more easily run, identify, and track execution by each component. Special behaviors may be configured per component this way, such as setting up different firewall rules for the executor and the service. An executor may be aware of DPI settings per monitor in some embodiments. As a result, workflows may be executed at any DPI, regardless of the configuration of the computing system on which they were created. Projects from designer 102 may also be independent of browser zoom level. For applications that are DPI-unaware or intentionally marked as unaware, DPI may be disabled in some embodiments.

FIG. 1B is another illustration of RPA development, design, operation, or execution 120. A studio component or module 122 may be configured to generate code, instructions, commands, or the like for a robot to perform one or more activities 124. User interface (UI) automation 126 may be performed by a robot on a client using one or more driver(s) components 128. A robot may perform activities using computer vision (CV) activities module or engine 130. Other drivers 132 may be utilized for UI automation by a robot to get elements of a UI. They may include OS drivers, browser drivers, virtual machine drivers, enterprise drivers, or the like. In certain configurations, CV activities module or engine 130 may be a driver used for UI automation.

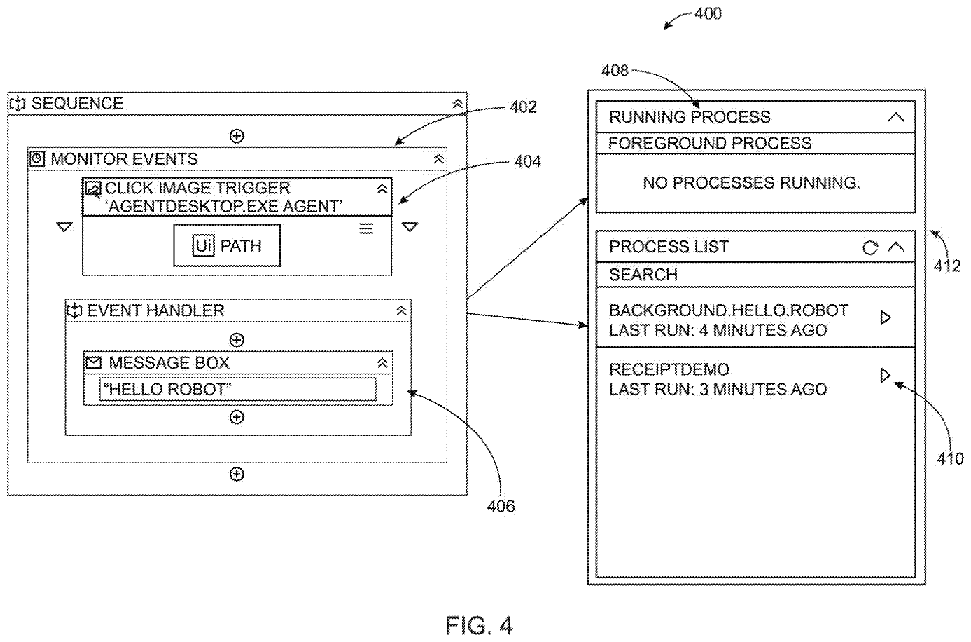

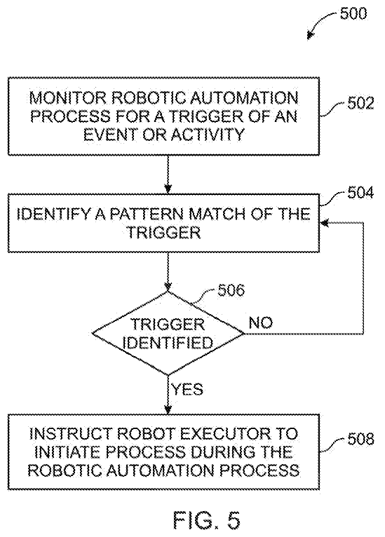

FIG. 10 is an illustration of a computing system or environment 140 that may include a bus 142 or other communication mechanism for communicating information or data, and one or more processor(s) 144 coupled to bus 142 for processing. One or more processor(s) 144 may be any type of general or specific purpose processor, including a central processing unit (CPU), application specific integrated circuit (ASIC), field programmable gate array (FPGA), graphics processing unit (GPU), controller, multi-core processing unit, three dimensional processor, quantum computing device, or any combination thereof. One or more processor(s) 144 may also have multiple processing cores, and at least some of the cores may be configured to perform specific functions. Multi-parallel processing may also be configured. In addition, at least one or more processor(s) 144 may be a neuromorphic circuit that includes processing elements that mimic biological neurons.

Memory 146 may be configured to store information, instructions, commands, or data to be executed or processed by processor(s) 144. Memory 146 can be comprised of any combination of random access memory (RAM), read only memory (ROM), flash memory, solid-state memory, cache, static storage such as a magnetic or optical disk, or any other types of non-transitory computer-readable media or combinations thereof. Non-transitory computer-readable media may be any media that can be accessed by processor(s) 144 and may include volatile media, non-volatile media, or the like. The media may also be removable, non-removable, or the like.

Communication device 148, may be configured as a frequency division multiple access (FDMA), single carrier FDMA (SC-FDMA), time division multiple access (TDMA), code division multiple access (CDMA), orthogonal frequency-division multiplexing (OFDM), orthogonal frequency-division multiple access (OFDMA), Global System for Mobile (GSM) communications, general packet radio service (GPRS), universal mobile telecommunications system (UMTS), cdma2000, wideband CDMA (W-CDMA), high-speed downlink packet access (HSDPA), high-speed uplink packet access (HSUPA), high-speed packet access (HSPA), long term evolution (LTE), LTE Advanced (LTE-A), 802.11x, Wi-Fi, Zigbee, Ultra-WideBand (UWB), 802.16x, 802.15, home Node-B (HnB), Bluetooth, radio frequency identification (RFID), infrared data association (IrDA), near-field communications (NFC), fifth generation (5G), new radio (NR), or any other wireless or wired device/transceiver for communication via one or more antennas. Antennas may be singular, arrayed, phased, switched, beamforming, beamsteering, or the like.

One or more processor(s) 144 may be further coupled via bus 142 to a display device 150, such as a plasma, liquid crystal display (LCD), light emitting diode (LED), field emission display (FED), organic light emitting diode (OLED), flexible OLED, flexible substrate displays, a projection display, 4K display, high definition (HD) display, a Retina© display, in-plane switching (IPS) or the like based display. Display device 150 may be configured as a touch, three dimensional (3D) touch, multi-input touch, or multi-touch display using resistive, capacitive, surface-acoustic wave (SAW) capacitive, infrared, optical imaging, dispersive signal technology, acoustic pulse recognition, frustrated total internal reflection, or the like as understood by one of ordinary skill in the art for input/output (I/O).

A keyboard 152 and a control device 154, such as a computer mouse, touchpad, or the like, may be further coupled to bus 142 for input to computing system or environment 140. In addition, input may be provided to computing system or environment 140 remotely via another computing system in communication therewith, or computing system or environment 140 may operate autonomously.

Memory 146 may store software components, modules, engines, or the like that provide functionality when executed or processed by one or more processor(s) 144. This may include an OS 156 for computing system or environment 140. Modules may further include a custom module 158 to perform application specific processes or derivatives thereof. Computing system or environment 140 may include one or more additional functional modules 160 that include additional functionality.

Computing system or environment 140 may be adapted or configured to perform as a server, an embedded computing system, a personal computer, a console, a personal digital assistant (PDA), a cell phone, a tablet computing device, a quantum computing device, cloud computing device, a mobile device, a smartphone, a fixed mobile device, a smart display, a wearable computer, or the like.

In the examples given herein, modules may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may be at least partially implemented in software for execution by various types of processors. An identified unit of executable code may include one or more physical or logical blocks of computer instructions that may, for instance, be organized as an object, procedure, routine, subroutine, or function. Executables of an identified module co-located or stored in different locations such that, when joined logically together, comprise the module.

A module of executable code may be a single instruction, one or more data structures, one or more data sets, a plurality of instructions, or the like distributed over several different code segments, among different programs, across several memory devices, or the like. Operational or functional data may be identified and illustrated herein within modules, and may be embodied in a suitable form and organized within any suitable type of data structure.

In the examples given herein, a computer program may be configured in hardware, software, or a hybrid implementation. The computer program may be composed of modules that are in operative communication with one another, and to pass information or instructions.

In the embodiments given herein, a robotic automation process of an application may be executed. A component or service within or in relation to a robotic automation process may listen or monitor for a trigger of an event or activity in relation to the robotic automation process or attended robot that is running in a system tray. In certain embodiments, a trigger may be defined with rules or an element in a definition file or a configuration file. The component or service may identify a match of a condition, a pattern, a sequence, or the like in relation to a trigger. When the trigger is identified, a robot executor may be instructed to initiate a process or sub-process during the robotic automation process.

One or more trigger events may be set by a user or operator. One or more triggers may be associated with each process in a list of processes. An identified process or sub-process may be executed if a monitoring or listening condition, pattern, sequence, or the like of an event or activity is matched. In example given herein, an RPA process may be referred to as a package, RPA package, or the like which each may include a workflow(s) for RPA automation.

A system may display managed processes or self-developed processes on an interface or UI. Execution of the identified process or sub-process may be initiated by clicking or selecting a programmed run button from the menu. The system may be configured to allow scheduling of processes such that managed or self-developed processes are configured for execution at a certain point in time or configured to remind the user to start the process manually.

Moreover, in certain configuration a system or component may monitor, listen, or wait for predetermined events or conditions such as a mouse event or keyboard event until a trigger condition or event is met, satisfied, or expires for an RPA process. To utilize trigger(s) for automation, a substantially always-on, real-time, or consistently on window service(s), set of service(s), windows process(es), set of process(es), or the like may be configured to monitor or listen for a user event(s), system event(s), file(s) changes, external events on another system, or the like in association with a defined trigger or definition of a trigger. In certain configurations when a trigger(s) engages, intelligent queue and scheduling may be utilized for an RPA process or automation.

Triggers may be coded in a studio component during development of a package, RPA package, RPA executable, or the like. In certain configurations, if a service is always monitoring or listening for an event, a package, RPA package, RPA executable, or the like, the service may utilize or be coded with selectors to enable or disable substantially all existing triggers by type(s), element activity, or the like.

A selector may be a reference or pointer to an element such as an image, text, or HTML tag in an application(s), a web page(s), or the like, that a RPA robot can utilize in an automation or process. A selector(s) may be mapped or saved to a package(s) in relation to a trigger event. This configuration may be utilized to enable or disable a trigger(s), use regular or typical expressions to match selectors against package(s), utilize static or dynamic input arguments for a package(s), or the like.

In certain configurations, trigger rules may be configured at development time, such as in studio, in relation to a process, package, RPA process, RPA package, RPA robot, a workflow of a package, RPA robot, or the like. A package may be an automation or RPA script that runs as an RPA robot. A package may be configured or referenced as a process or robot and be configured to invoke or start one or more other packages via a channel or connector. An RPA robot may be an application running on a machine that executes packages or other code.

A trigger rule or definition may contain a target(s), which may be a selector, windows process, a file or folder, or the like, and the type of trigger(s). The type of trigger(s) may include click triggers, keyboard triggers, process triggers, file change triggers, or the like. A trigger rule or definition may also contain an event(s), which may include a process or package to execute, pause, stop, an additional setting/pausing/canceling of triggers, a process start/stop, external events, or the like. The event may be related to a default priority or filters and extra conditions needed to satisfy a trigger rule or definition.

A trigger may comprise information in relation to an event(s) trigger for a set rule, information to set a trigger, information to set a trigger rule, additional or extra criteria needed for the rule to be triggered or suppressed, an action(s) related to a rule, rule priority, quality of service (QoS) factors for a rule, or the like. In addition, a trigger rule or definition may indicate if a rule or part of a rule can be edited locally on a client device.

A user or operator may utilize a service on a client device or environment, such as through a robot tray or a third-party application integrated with the RPA robot, to turn on a trigger(s), turn off a trigger(s), set user specific criteria for a trigger(s), view access policies/rights for a trigger(s), configure access policies for a trigger(s), create a new user specific trigger, or the like. In certain configurations, a process or sub-process may be configured to dynamically define, enable, disable, or the like a trigger(s) based on a pre-determined criteria. For example, a process(es) may enable a trigger, as needed, once at a time point, a flow point, a sequence point, or the like is reached.

FIG. 2 is an illustration of an example of in-process trigger monitoring, listening, or management 200. Robot 202 may be setup, programmed, arranged, developed, or the like by a developer 204. A center of excellence (COE) developer team 206 may deploy a self-developed or managed process. One or more UI elements related to one or more triggers may be mapped or configured in relation to a self-developed or managed process. A self-developed trigger may be a newly programmed code package. A trigger of a managed process may be deployed in relation to an existing definition or configuration. Robot 202 may be configured as attended or unattended. Moreover, robot 202 may be configured on client device or machine 208 to monitor (1) or listen for one or more triggers of one or more UI elements.

Once one or more triggers in relation to one or more UI elements is matched (2) to an activity, a self-developed or managed process may run (3) or execute. A match may be based on a condition, a pattern, a sequence, or the like. The self-developed or managed process may be in relation to any of the automations given herein. In addition, the process may run in collaboration with other robots, based on an event, that is distributed among other unattended robots configured in robotic shared service center 210.

For the embodiments given herein, a trigger or trigger event(s) may comprise one or more of a mouse click(s), keyboard event(s), keyboard press(es), image click, touch input(s), screen input(s), on-screen element change, process start, process stop, file change, folder change, universal resource locator (URL) input, navigation input, replay event, undesirable online user navigation, desirable user navigation, external trigger, an event on another system, or the like. In examples given herein, a robot may be configured to execute a different process(es) when a mouse click(s) is a right click, left click, or the like. Screen element input event(s) may comprise identification of clicking certain element(s) on the interface, such as create record, apply, etc., or monitor of certain element(s) appearing on screen or display.

A mouse trigger component may monitor, such as with a monitor event activity or object, a specific mouse key input, click, button, or combination with other inputs or keys related to an activity. The activity may be a system wide event. A mouse input, activity, or action may be performed in relation to a UI element or object.

A system trigger component may be configured to monitor a specified system-wide key, keyboard, or mouse event in relation to a monitor event activity. In certain configurations, a system trigger may be associated with an event mode for blocking actions on a UI element. In addition, a click trigger may monitor click events, including children elements, on a specified UI element within a monitor events activity. A click may be a mouse button input or text selection related to a graphical user interface (GUI) element. A click may be associated with a clipping region of a clipping rectangle, in pixels, relative to a UI element and associated UI directions. The monitored event activity may be synchronous or asynchronous. Furthermore a click trigger may be associated with an event mode for possible blocking actions on a UI element.

A key press trigger component may be related to monitoring a keyboard, touchpad, trackpad, touchscreen, or the like events on a specified UI element or object in relation to a monitor events activity. Variables for this trigger may include key, special key, a selector for a text property to find a particular UI element or object when the activity is executed, or the like. Other variables may include synchronous event type, asynchronous event type, children of the UI element, a key press action that is blocked for a UI element, and a selected key modifier to the activity. In addition, a hot-key trigger may monitor a specified system-wide key, including special key or windows hot-key, event within a monitor events activity. An event mode may specify that a key press is blocked from acting on UI elements. A hot-key may be associated with an event mode for possible blocking of actions on a UI element.

For the embodiments given herein, a replay user event may replay a user event that was that was blocked as part of a trigger, trigger definition, trigger configuration, or the like. A replay may be associated with a key press trigger or click image trigger. A replay may be associated with a monitored event activity. The monitored event activity may be synchronous or asynchronous.

In certain configurations, a block user input may be utilized in a container or package that disables a mouse and keyboard when activities inside it run. This component may be configured to block either mouse, keyboard, special key, or both inputs. This component may permit a designated hot-key combination to re-enable a user input. In addition, a control parameter set to continue on error may specify if the automation may continue or cease when an activity throws an error or exception.

A monitor or listen event component may listen for multiple activities or triggers and execute the activities specified in an event handler container or package. For event frequency, a control parameter set to true may block execution every time the trigger is activated. For a control parameter set to false, the activity may execute one time. A control parameter set to continue on error may specify if the automation should continue or cease when an activity throws an error or exception.

A get source component may extract an UI element or object in relation to a performed action or activity for a trigger. Activities for this element may include a key press trigger, click image trigger, click trigger, or the like. This element may be performed within a monitor event(s) activity. Similarly, a get event info component may enable extraction of different types of information related to a trigger.

Also for the embodiments given herein, for changes to a file(s) or folder(s), certain configurations may identify addition, deletion, changes, or the like of certain files or folders as a trigger. Identification may be performed by monitoring changes in a file name, a file path, file properties, or the like. These trigger events can be set by the user and associated with each process in a list or set of processes. An identified process or sub-process may be executed if a monitored condition is matched or met. Certain configurations may also allow triggering a process by providing the user interface to initiate execution of RPA process(es). Managed processes and self-developed processes may be displayed on an interface and, on clicking a run button from the menu, execution of the identified process may be initiated. In addition, processes may be scheduled such that managed and self-developed processes are configured to be executed at certain point in time.

A click image trigger component may monitor an image defined by the target UI element for input, such as a mouse input, mouse click, or touch input. Image accuracy may be related to this trigger such that a unit of measurement from 0 to 1 may express minimum similarity between an image being searched and one to be found. Image profile may be utilized to change or select an image detection algorithm, such as basic or enhanced detection. This trigger component may be related to a clipping region for clipping a rectangle, in pixels, relative to the UI element and related a UI direction. A selector may be associated with a text property for this trigger component. Event type may include synchronous event type, asynchronous event type, or the like.

FIG. 3 is an illustration of an example of process queue management for a robot(s) 300. A process queue may be configured locally on a machine or client device for any type of robot, such as an attended robot. A request(s) for automation may come from one or more different sources for robot automation. As described herein, a trigger(s) component may detect, such as through monitoring or listening, a change to the file system, a user or operator set process, a newly scheduled process, or the like. In configurations with a workflow(s) in a same package(s), an internal or intelligent queuing component may accept and queue a request(s) sequentially. However, in certain configurations sequential request processing may be undesirable when a request(s) for automation comes from one or more different sources.

In configuration 300, for queue management for a robot(s), robot service 302 may use process queue component 310 to start, stop, or pause one or more robot executors 306 of which there may be one or multiple-overlapping requests. Interface 308 may be configured to display current RPA robot actions, events, or activities of one or more robot executors 306.

A request may be one received from a service or component. A set of rule constructs, criteria, or default condition may be configured so that a robot may assess a process(s) to deliver a performance level, responsiveness, QoS, or the like. If requests overlap, a rule or criteria may be utilized by robot service 302 to select a request for one or more services, processes, or workflows. Robot service 302 may communicate with and receive requests from various entry point components 304 to start or initiate a process. The various entry points include a triggered process component, a scheduled process component, a manually start process component, or an auto-start process component for managing a queue with process queue component 310.

In configuration 300, a robotic process may be associated with a base priority related to the process request source, the time of day, a pre-configured value, or the like. In addition, if a process is configured for foreground or background operation, queuing may be skipped and the process may be executed in parallel. As such, configuration 300 provides different mechanisms for a request to start, stop, or pause a process, a robotic process, a service, a robotic service, or the like. In addition, process queue component 310 may allow a robot service to ensure a request is delivered or saved for later processing.

Manual start process component may, including in substantially real-time, receive command(s) or input(s) from a user to observe process queue component 310 and reprioritize, cancel, or add additional requests. In addition, a high or higher priority process(es) may be configurable to override another foreground or background operation. A user or operator input may also pause a current process so that a high or higher priority process(es) completes with or without using additional resources on a client device, server, or system.

FIG. 4 is another illustration of in-process trigger monitoring or listening 400. A monitor events process 402 may listen for a match activity of a click on image trigger 404. If a match is made, event handler 406 will display message box “Hello Robot.” Monitor events process 402 may be a running process 408 or queued in process list 410 that is displayed on interface 412.

FIG. 5 is an illustration of an example of a process for in-process triggering 500. A robotic automation process may be monitored, such as by a service or component, for a trigger of an event or activity (502). This may be performed within, during, or in the robotic automation process. A pattern match for a trigger may be identified (504). If a trigger is identified (506), a robot executor may initiate a process during the robotic automation process (508). Otherwise, the service or component continues to listen and attempt to identify a pattern match for a trigger.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A computing device comprising:
a processor and a memory configured to execute a robotic automation process of an application;
the processor is further configured to monitor, in relation to the robotic automation process, for an event or an activity associated with a trigger, wherein the trigger is defined by code, a definition file, or a configuration file;
the processor is further configured to identify a match for the event or the activity associated with the trigger; and
the processor is further configured to instruct, on a condition that the trigger is identified, a robot executor to initiate a process during the robotic automation process.

2. The computing device of claim 1, wherein the code, the definition file, or the configuration file defines rules or elements for the trigger.

3. The computing device of claim 1, wherein the process is from a list of processes associated with the trigger.

4. The computing device of claim 1, wherein the trigger is associated with a time point, a flow point, or a sequence point during the robotic automation process.

5. The computing device of claim 1, wherein user interface (UI) elements related to the trigger are mapped or configured in relation to the process.

6. The computing device of claim 1, wherein the match comprises matching user interface (UI) elements of the application.

7. The computing device of claim 1 further comprising a queue configured to manage requests for the robot executor in relation to the robotic automation process.

8. The computing device of claim 1, wherein the event or the activity is any one of a mouse click, a keyboard event, an image click, a touch input, process start, process stop, file change, folder change, universal resource locator (URL) input, navigation input, replay event, undesirable online user navigation, desirable user navigation, an external trigger, or an event on another system.

9. A method performed by a computing device, the method comprising:
executing a robotic automation process of an application;
monitoring, in relation to the robotic automation process, for an event or an activity associated with a trigger, wherein the trigger is defined by code, a definition file, or a configuration file;
identifying a match for the event or the activity associated with the trigger; and
instructing, on a condition that the trigger is identified, a robot executor to initiate a process during the robotic automation process.

10. The method of claim 9, wherein the code, the definition file, or the configuration file defines rules or elements for the trigger.

11. The method of claim 9, wherein the process is from a list of processes associated with the trigger.

12. The method of claim 9, wherein the trigger is associated with a time point, a flow point, or a sequence point during the robotic automation process.

13. The method of claim 9, wherein user interface (UI) elements related to the trigger are mapped or configured in relation to the process.

14. The method of claim 9, wherein the match comprises matching user interface (UI) elements of the application.

15. The method of claim 9 further comprising managing, by a queue, requests for the robot executor in relation to the robotic automation process.

16. The method of claim 9, wherein the event or the activity is any one of a mouse click, a keyboard event, an image click, a touch input, process start, process stop, file change, folder change, universal resource locator (URL) input, navigation input, replay event, undesirable online user navigation, desirable user navigation, an external trigger, or an event on another system.

17. A computing device comprising:
a processor and a memory configured to execute a robotic automation process of an application;
the processor is further configured to monitor, in relation to the robotic automation process, for an activity associated with a trigger, wherein the trigger is defined by a configuration file;
the processor is further configured to identify a match for the activity associated with the trigger; and
the processor is further configured to instruct, on a condition that the trigger is identified, a plurality of robot executors to execute a process during the robotic automation process.

18. The computing device of claim 17 further comprising a queue configured to manage requests for the plurality of robot executors in relation to the robotic automation process.

19. The computing device of claim 17, wherein the process is from a list of processes associated with the trigger.

20. The computing device of claim 17, wherein the trigger is associated with a time point, a flow point, or a sequence point during the robotic automation process.
